(19) United States
(12) Patent Application Publication
(10) Pub. No.: US 2015/0234884 A1
(43) Pub. Date: Aug. 20, 2015

(54) System and Method Involving Resource Description Framework Distributed Database Management System and/or Related Aspects

(71) Applicant: SparkleDB AS, Sunnyvale, CA (US)

(72) Inventor: Inge Eivind Henriksen, Sunnyvale, CA (US)

(21) Appl. No.: 14/232,243

(22) PCT Filed: Nov. 8, 2013
(86) PCT No.: PCT/US2013/069352

§ 371 Date: May 8, 2015

Related U.S. Application Data
(60) Provisional application No. 61/724,200, filed on Nov. 8, 2012.
(60) Provisional application No. 61/751,132, filed on Jan. 10, 2013.

(51) Int. Cl. G06F 17/30

(52) U.S. Cl. CPC G06F 17/30359; G06F 17/30477; G06F 17/30587; G06F 17/30864; G06F 17/30581

(57) ABSTRACT

Implementations herein pertain to database management, such as systems and methods involving Resource Description Framework (RDF) Distributed Database Management Systems (DDMS) and/or related aspects.

### CROSS-REFERENCES TO RELATED APPLICATION(S)

This application claims benefit/priority of U.S. provisional patent application No. 61/724,200, filed Nov. 8, 2012, and U.S. provisional patent application No. 61/751,132, filed Jan. 10, 2013, all of which are incorporated herein by reference in entirety.

### BACKGROUND

1. Field

Aspects of innovations herein generally pertain to database management, such as systems and methods involving Resource Description Framework (RDF) Distributed Database Management Systems (DDMS) and/or related aspects.

2. Description of Related Information

At present there is a high demand for anytime, anywhere access to structured data provided via telecommunications and/or data networks. Even though technical solutions to this problem are already available, there are problems managing, aggregating, and extraction useful information from big data sets in a timely fashion.

A distributed database management system (DDBMS) assists in maintaining and utilizing large collections of data, or otherwise referred to as “big data”. The need for such systems, as well as their use, is growing rapidly. The alternative to using a DDBMS is to store the data in a single database server or in files and write application-specific code to manage it.

Conventional solutions attempt to manage large amounts of structured data. One known example, which this inventor/applicant considers the closest art related to this invention is the Virtuoso Universal Server that is claimed to provide enterprise grade multi-model data server for agile enterprises and individuals, and to deliver a platform agnostic solution for data management, access, and integration. This existing solution is not a pure Resource Description Framework (RDF) data store, but a universal database that has several logical data models in addition to the RDF data model. However, this architecture causes slow data

processing due to the constant translation between its native data model and the abstract data models like RDF. This solution does not comply with the RDF Schema recommendation and is not fully compliant to the SPARQL Protocol and RDF Query Language (SPARQL) 1.1 recommendation. The solution does, however, comply with the SPARQL query/update language and SPARQL protocol recommendation, and is horizontally scalable. This approach works with most modern programming languages and operating systems.

Another existing solution on the market is AllegroGraph. This solution is not horizontally scalable so as to not support big data, and does not have an update language that complies with the SPARQL 1.1 Update recommendation and does not comply with the RDF Schema recommendation. This solution does, however, comply with the SPARQL query language and SPARQL protocol recommendation. This solution only works with the LINUX operating systems and claims to be a RDF data store, but in fact stores the data in a graph data model, where this architecture causes slow data processing due to the constant translation between its graph data model and the abstract RDF data model.

Another existing product is Oracle Database. This product does not comply with any of the SPARQL query/update language recommendations, the RDF Schema recommendation, and the SPARQL Protocol recommendation. This solution works with most modern programming languages, is horizontally scalable. However, the Oracle Database is not a pure RDF data store, but a universal database that has several logical data models in addition to the RDF data model, where this architecture causes slow data processing due to the constant translation between its native object-relational data model and the abstract data models like RDF.

Another solution is IBM DB2 database software. This solution does not comply with any of the SPARQL query/update language recommendations, the RDF Schema recommendation, and the SPARQL Protocol recommendation. This solution works with most modern programming languages and operating systems, is horizontally scalable, and is not a pure RDF data store, but a universal database that has several logical data models in addition to the RDF data model, where this architecture causes slow data processing due to the constant translation between its native object-relational data model and the abstract data models like RDF.

While existing solutions are considered good enough for maintaining and utilizing small collections of structured data, they are not adequate enough for maintaining and utilizing large collections of structured data due to their bad system architecture and the lack of standards compliance.

As such, advantages of aspects of certain innovations herein relate to providing database server solutions and related products which process structured data faster than present solutions, while at the same time offering a high level of standard compliance.

### BRIEF DESCRIPTION OF THE DRAWINGS

The accompanying drawings, which constitute a part of this specification, illustrate various implementations and aspects of the innovations herein and, together with the description, help illustrate the principles of the present inventions. In the drawings:

FIG. 1 is a block diagram of a database management system consistent with certain aspects related to the innovations herein.

FIG. 2 is a block diagram of another database management system consistent with certain aspects related to the innovations herein.

FIG. 3 is a block diagram of another database management system consistent with certain aspects related to the innovations herein.

FIG. 4 is a block diagram of another database management system consistent with certain aspects related to the innovations herein.

FIG. 5A is a high-level block diagram of database engine modules consistent with certain aspects related to the innovations herein.

FIG. 5B is a detailed block diagram of database engine modules consistent with certain aspects related to the innovations herein.

FIG. 6 depicts illustrative implementations/components of a distributed database management system (DDBMS) including a slave database node 600 and associated components and features, consistent with aspects related to the innovations herein.

FIG. 7 illustrates one implementation of a client/server execution flow, consistent with aspects related to the innovations herein.

FIG. 8 is a flow chart illustrating exemplary query processing consistent with certain aspects related to the innovations herein.

FIG. 9 is a flow diagram of illustrative database engine processing consistent with certain aspects related to the innovations herein.

### DETAILED DESCRIPTION OF THE ILLUSTRATIVE IMPLEMENTATIONS

Reference will now be made in detail to the inventions herein, examples of which are illustrated in the accompanying drawings. The implementations set forth in the following description do not represent all implementations consistent with the claimed inventions. Instead, they are merely some examples consistent with certain aspects related to the present innovations. Wherever possible, the same reference numbers will be used throughout the drawings to refer to the same or like parts.

Systems and methods involving innovative distributed database server(s) herein may provide various utilizations of the data to insulate application code from details of data representation and storage, and utilize a variety of sophisticated techniques to store and retrieve data efficiently. According to some implementations, for example, an exemplary distributed database server may present itself as a single database system even though it consists of loosely coupled database server nodes that may share no physical components.

### OVERVIEW

Aspects of innovations herein generally relate to database management systems and distributed database management systems, referred here together as distributed database management systems or DDBMS. Implementations may include software that is designed to assist in maintaining and utilizing large collections of structured data on a single computer or several connected computers, enterprise mainframes, or Software as a Service (SaaS) in a cloud computing scenario, e.g. a database cloud. The amount of unstructured data available is literally exploding, and the value of structured data as an asset is widely recognized.

Implementations of the present inventions generally provide a computer software program product enabling users, hardware systems and computer programs to maintain and utilize large collections of structured data in a data system or over a telecommunications network. One implementation, referred to as the distributed database server, can manage one or several collections of structured data on a single server or distributed over several servers over a telecommunications network.

Yet another implementation herein includes a proprietary ODBC driver module which connects a computer program with an associated DDBMS catalog based on a first set of data related to a user, a second set of data related to a password, a third set of data related to a database server network address, a fourth set of data related to the database catalog, and a fifth set of data related to a database server network server listening port and/or network protocol.

In yet another implementation according to the present innovations a proprietary graphical user interface referred to as DBA Studio is included which connects a user with an associated DDBMS catalog based on a first set of data related to a user, a second set of data related to a password, a third set of data related to a database server network address, a fourth set of data related to the database catalog, and a fifth set of data related to a database server network server listening port and/or network protocol. This implementation is an integrated environment for accessing, configuring, managing, administering, and developing all components of the DDBMS.

In yet another implementation according to inventions herein, the solution includes a proprietary graphical management console user interface that allows a remote user to receive a graphical overview of the entire database, write SPARQL queries and manage database user access control.

Yet another implementation according to the present innovations may include a proprietary JDBC driver module which connects a computer program with an associated DDBMS catalog based on a first set of data related to a user, a second set of data related to a password, a third set of data related to a database server network address, a fourth set of data related to the database catalog, and a fifth set of data related to a database server network server listening port and/or network protocol.

In other implementations, the solution may include a proprietary distributed database server transaction protocol (DDSTP) endpoint. Such implementations may run on a database node in the distributed database or on a standalone server.

Still other implementations may include a proprietary web server mainly intended for data interchange. These implementations may run on the master node of the distributed database or on a standalone server.

In yet another implementation of the innovations herein, the solution may include a SPARQL Protocol endpoint. This embodiment runs on an instance of the proprietary web server.

Still another implementation of systems, methods or computer program products herein may include an installer application that installs, repairs, or uninstalls the DDBMS embodiments on an operating system.

Various implementations of the distributed database server, systems and methods herein may be configured with one or more advantageous features. For example, the distributed database server can transparently add or remove database servers to match requirements and specifications. This feature adds big data support to the inventions herein, thus enabling the storage and retrieval of potentially limitless amounts of data. The distributed database server can enforce data integrity constraints and enforce access controls that govern what data is visible to different classes of users. A plurality of users and computer programs can access and manage the structured data on the distributed database server at the same time. The distributed database server may schedule concurrent access to the data in such a manner that users can think of the data as being accessed by only one user at a time. The distributed database server ensures that application programs are as independent as possible from details of data representation and storage. The distributed database server can provide an abstract view of the data to insulate application code from such details. The distributed database server software can run on operating systems like Windows®, UNIX, Sun, Linux, and other POSIX-compatible operating systems. The distributed database server fully supports atomicity, consistency, isolation, durability features (ACID) that guarantee that all the distributed database server transactions are processed reliably.

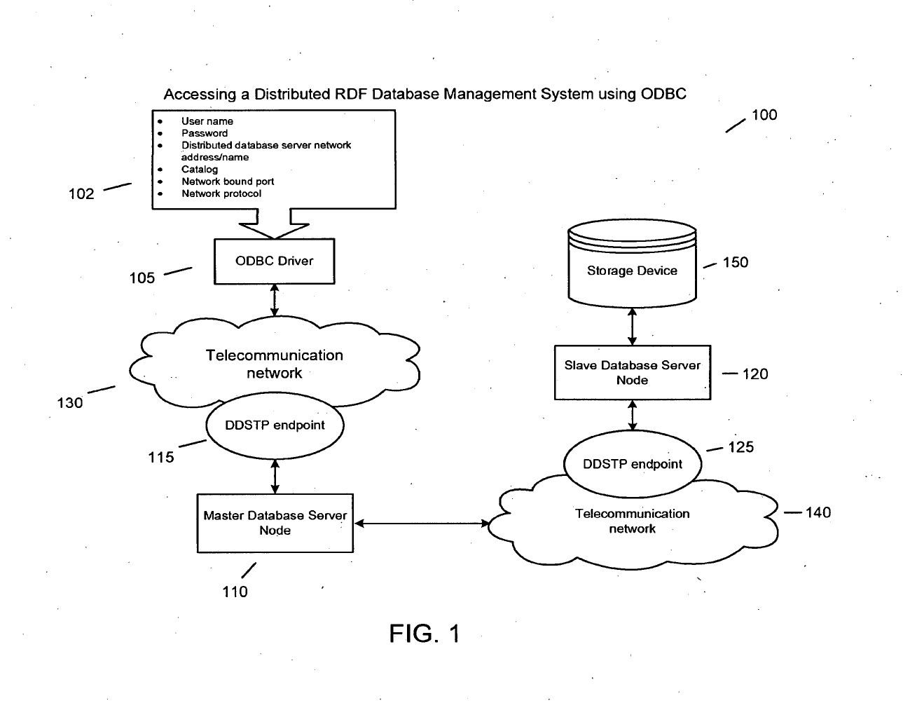

FIG. 1 shows one abstract illustration of how different users/clients connect and manage a distributed database server 110 using software drivers and API's, such as an Open Database Connectivity (ODBC) driver(s) herein, consistent with aspects of the present innovations. Required information 102 is input and passed to the ODBC driver 105. The driver 105 then connects to the master database node's DDSTP endpoint 115 over a telecommunications network 130. After a successful connection, the ODBC driver 105 communicates with and manages the database 110 over the established connection via the DDSTP endpoint. The master database server node 110 may connect, manage, and communicate with one or more slave database server nodes 120 over a telecommunications network 140 by using a corresponding DDSTP endpoints 125. The slave database server nodes 120 may perform CRUD operations on their assigned storage devices 150.

Further, the DDBMS 100 may contain a connectivity application programming interface (API) to enable application programs to access the distributed database server 110, 120 and its databases over a telecommunications network. The proprietary and native Open Database Connectivity (ODBC) driver is a middleware API for accessing the distributed database server over a telecommunications network. The driver may be installed by an installer on the computer or device that accesses the distributed database server. The driver 105 connects and communicates with the distributed database server 110, 120 using its DDSTP endpoint 115. The ODBC driver 105 enables one or several client's simultaneous access to the distributed database server 110, 120, and works with modern programming languages in addition to many existing software applications and systems. In some implementations, the ODBC driver performs query parsing, query optimizing, and query plan evaluation using database statistics before the selected query execution plan is sent to the distributed database server. Systems and methods implementing this architecture design are particularly innovative, inter alia, they save resources on the distributed database server. The ODBC driver 105 queries the master database server node 110 for database statistics when this is required and caches these statistics for a configurable number of minutes to prevent query hammering.

The proprietary and native JDBC driver is a standard middleware Java API for accessing the distributed database server over a telecommunications network. The driver is installed by an installer that accesses the distributed database server. The JDBC driver enables one or several client's simultaneous access to the distributed database server, and works with the Java programming language in addition to other existing software applications and systems.

Users manages the distributed database server by accessing and using its proprietary distributed database server transaction protocol (DDSTP) endpoint or its SPARQL Protocol endpoint over a telecommunications network. The proprietary ODBC driver 105 uses the distributed database server's DDSTP endpoint 115 when it connects and communicates over a telecommunications network 130 with the distributed database server 110. The DDSTP endpoint 115 is a native connection-oriented, stateless, binary application protocol. A user performs create, read, update, and delete (CRUD) operations on the distributed database server by with SPARQL 1.1 and SPARQL 1.1 Update queries over the DDSTP 115. These declarative query and update languages comply with the W3C recommendations and current working drafts and is the Data Manipulation Language (DML) of choice. Database statistics are used to calculate the likely processing time for each user requested SPARQL query and the endpoints 115, 125 can be configured to stop queries that take to long to process before the query is executed, thus preventing long running queries from consuming large amounts of database server system resources and also preventing denial of service attacks.

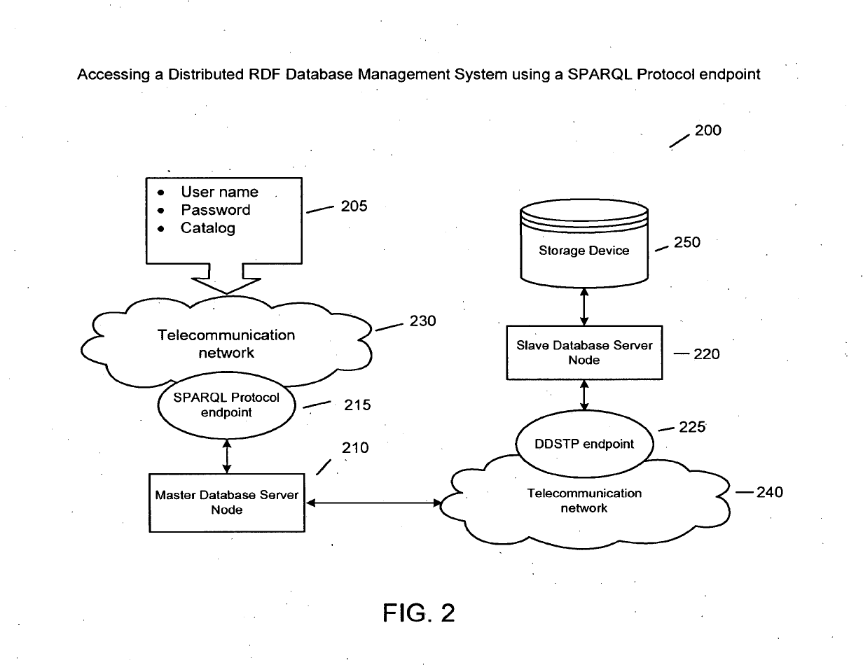

FIG. 2 shows one illustration of how an application program connects and manages a distributed database server 210 using SPARQL Protocol endpoint(s) 215, 225 herein, consistent with aspects of the present innovations. The user/client inputs required information 205 and passes it to the master database server node's web server SPARQL Protocol endpoint 215 over a telecommunications network 230. After a successful connection, the user/client communicates with and manages the database 210 over the established connection via the SPARQL Protocol endpoint 215. The master database server node 210 may connect, manage, and communicate with slave database server nodes 220 over a telecommunications network 240 by using corresponding DDSTP endpoints 225. The slave database server nodes 220 may perform CRUD operations on their assigned storage devices 250.

Every database server in the distributed database server serves as a node with specific tasks. In the distributed database server systems of FIGS. 1 and 2, there is a single master database server node and one or more slave database server nodes. The master database server node's manages all the indexes and data files in the distributed database server.

The master database server node also manages the write-ahead log, and protects the distributed database server data from the effects of system failures. The master database server node provides tasks to the slave database server nodes. The master database server node connects and communicates with the other nodes of the distributed database server using their DDSTP endpoint. If the DDBMS is configured to have several master database server nodes then some data is replicated between them like the transaction log and the system catalog RDF repository.

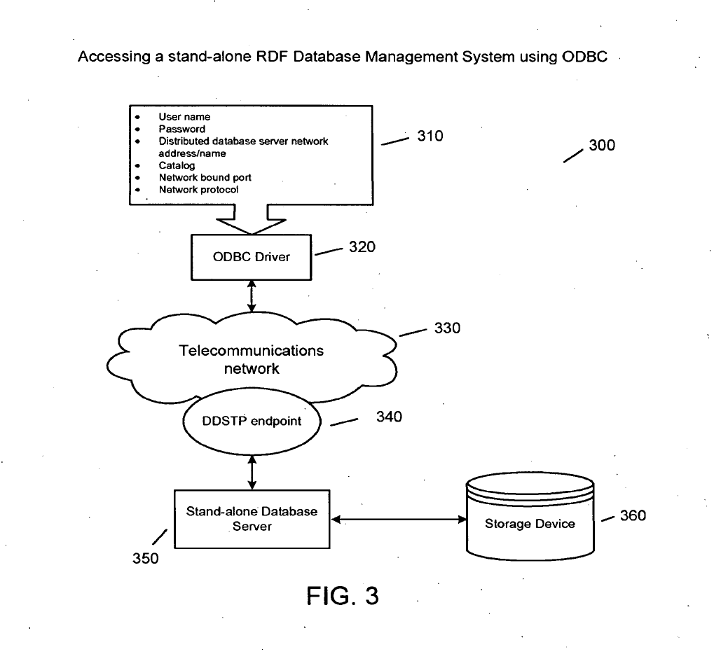

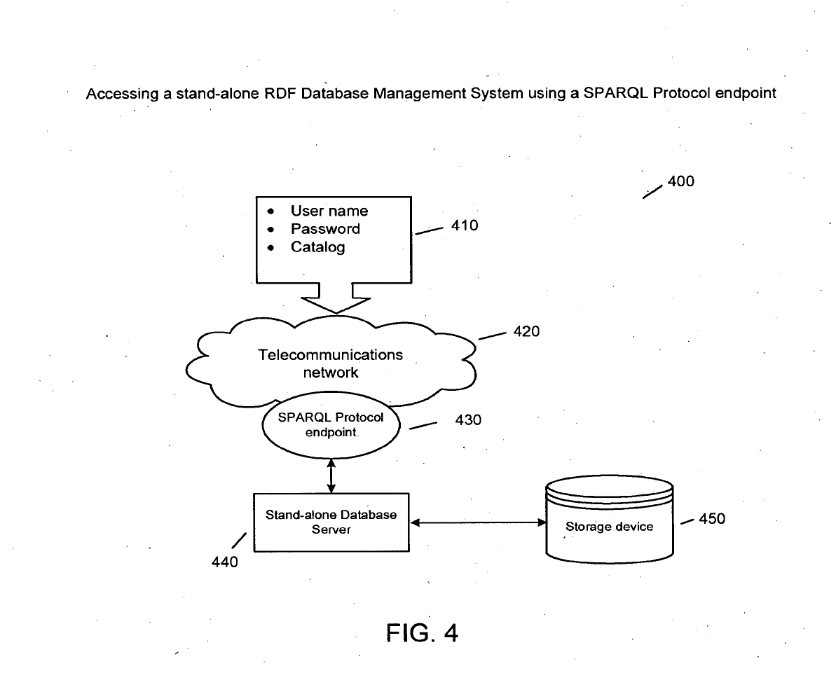

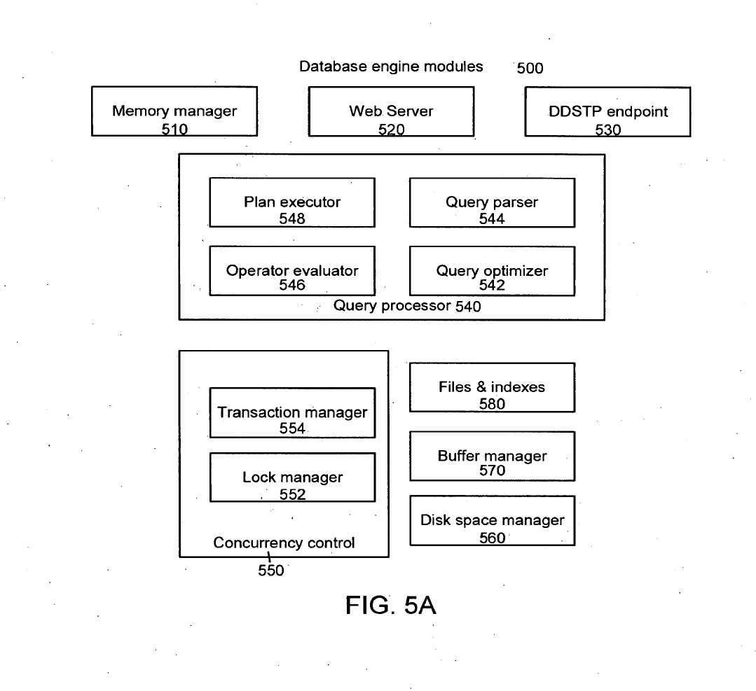

In the configuration of a single database server (FIGS. 3 and 4) that handles both master and slave database node tasks, the database server is a standalone database server. In an alternative configuration, several master database server nodes can concurrently execute in separate processes on a single server, where each master database server node is addressed as a named instance for access to the master database server node. The master database server node also handles crash recovery by utilizing the recovery manager and the write-ahead transaction log (WAL) to ensure data durability and database transaction atomicity. All database server node network bindings are configurable.

FIG. 3 shows one illustration of how a user/client connects and manages a stand-alone database server 350 using an ODBC driver 320, consistent with aspects of the present innovations. The user/client provides the required information 310 and passes it to the ODBC driver 320. The driver 320 then connects to the stand-alone database's DDSTP endpoint 340 over a telecommunications network 330. After a successful connection, the ODBC driver 320 communicates with and manages the database 350 over the established connection via the DDSTP endpoint 340. The database server 350 may perform CRUD operations on its assigned data storage devices 360 such as hard disks.

FIG. 4 shows one illustration of how a user/client connects and manages a stand-alone database server 440 using the SPARQL Protocol endpoint 430, consistent with aspects of the present innovations. The user/client provides the required information 410 and passes it to the master database server node's web server SPARQL Protocol endpoint 430 over a telecommunications network 420. After a successful connection, the user/client communicates with and manages the database 440 over the established connection via the SPARQL Protocol endpoint 430. The database server 440 may perform CRUD operations on its assigned data storage devices 450 such as hard disks.

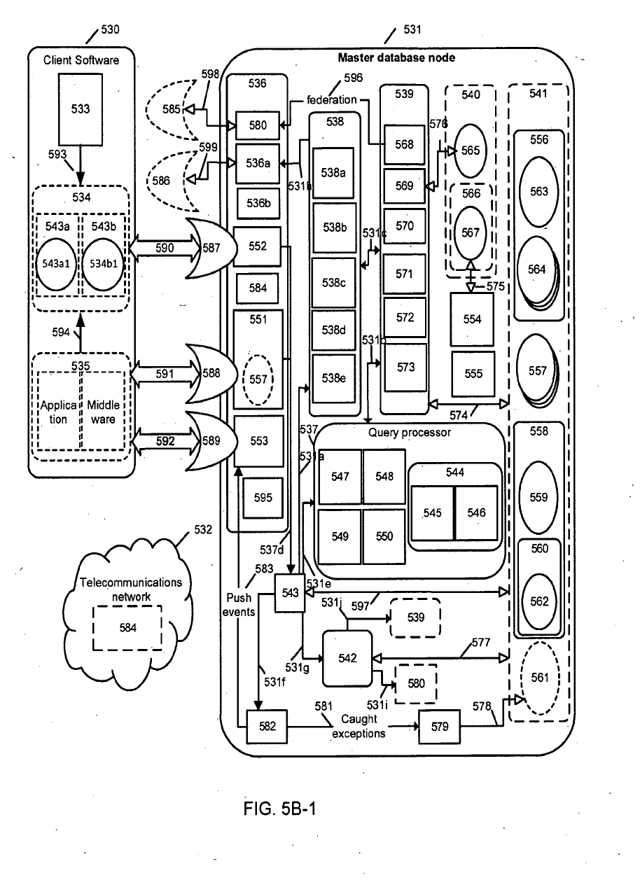

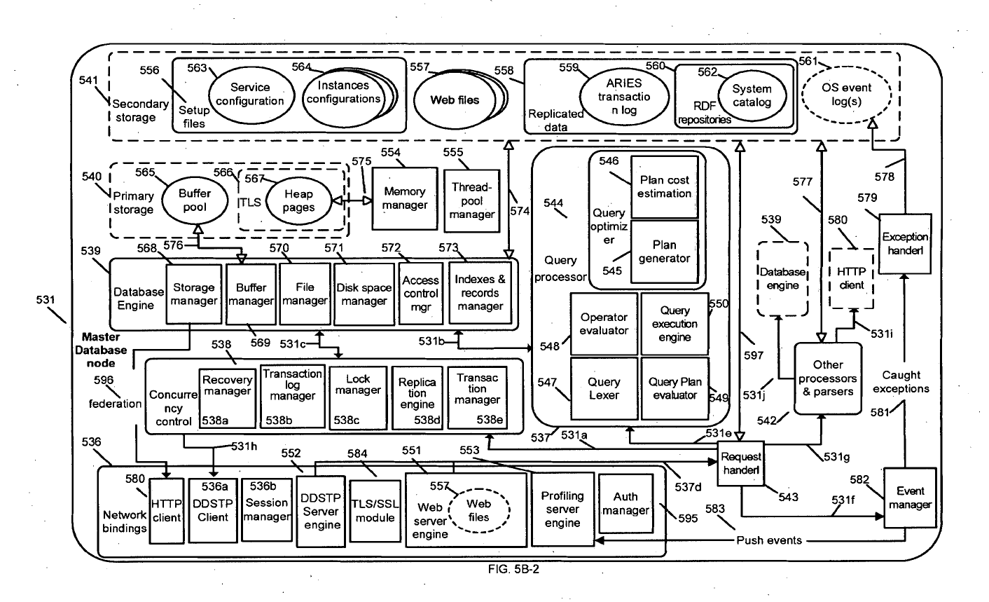

FIG. 5A shows an overview of the modules 500 of the stand-alone, master or slave database server nodes, also referred to as the database engine, consistent with aspects of the present innovations. Among the modules is an in-process query optimizer 542 that determines the most efficient way to execute a query, an in-process memory manager 510 for faster heap memory allocation and de-allocation, an in-process multi-threaded Web server 520 for a much faster SPARQL Protocol data interchange than through a standard out-of-process web server, and an in-process directly-coded lexical analyzer 544 for efficient query parsing, snapshot isolation 554 for fast transaction processing, lightweight lock management 552 within concurrency control 550. The modules 500 represent an RDF data model such that there is no data model abstraction layer to slow down data processing, a binary connection-oriented and state-less DDSTP endpoint 530 for efficient communication with application programs over a telecommunications network, a files and indexes directory 580, a buffer manager 570 that caches disk sectors to internal memory pages for fast access when a disk sector is repeatedly requested by the database engine, a disk space manager 560 that handles all disk access in a manner that indexes and files 580 can be accessed efficiently by many concurrent threads.

A query optimizer 542 may be included, being a component of the distributed database management system to determine the most efficient way to execute a query. The query optimizer considers the possible query plans for a given input query and determines the most efficient query execution plan, providing ease to users to write efficient queries.

FIG. 5B depicts illustrative implementation(s) of master database management system (DBMS) including a master database node 531 and associated components and features, consistent with aspects related to the innovations herein. As set forth in FIG. 5B, the master DBMS may include a master database node 531, a client 530, a network 532 connecting the elements, and various communication/protocols associated with the master 531 and client 530, such as DDSTP 590, HTTP/HTTPS 591, raw text 592 and associated endpoints.

Referring to FIG. 5B, the client software 530 connects to the master database service 531 over a network 532, such as a telecommunications network. With regard to exemplary driver operation, the SparkleDB ODBC driver 534a1 is managed by an ODBC driver manager 534a, and the SparkleDB JDBC driver 534b1 is managed by the JDBC driver manager 534b. Further, the SparkleDB JDBC driver 534b may use the SparkleDB ODBC driver 534a.

A SparkleDB ODBC driver 534a1 or a SparkleDB JDBC 534b1 driver is required client software 530 to manage 590 with a SparkleDB DDBMS over a DDSTP endpoint 587 network endpoint 536. The DDSTP endpoint 587 is managed by the DDSTP server engine 552 network binding 536. The DDSTP server engine 552 runs in the same process as the database node instance. The DDSTP server engine 552 can be configured 564 to enable TLS/SSL data encryption 584 with server certificates and optionally client certificates by the DBA in the database node 531 instance configuration file 564. Client TLS/SSL certificates are stored in the secondary storage on the client system 530. Server TLS/SSL certificates are stored in the secondary storage 541 on the server system 531 and managed by the TLS/SSL module 584. The context related to each client 530 connected to the DDSTP server engine 552 is handled by a session manager 536b to prevent re-authentication after a network 532 disconnection of the client 530. Client authentication is handled by the Authentication Manager 595.

Database server nodes communicate via DDSTP 590 with each other using DDSTP client 536a modules and DDSTP endpoints 586 over a network 532. Master database server nodes 531 can communicate with HTTP endpoints 586 using a HTTP client module 580, for example when doing federated queries 596. If federated queries 596 is enabled in the configuration file 564 the user can perform federated SPARQL queries 596 if so required.

In one illustrative implementation, the HTTP endpoint 588 supports the SPARQL 1.1 Protocol as defined by the W3C Recommendation dated Mar. 21, 2013. The HTTP endpoints 588 is managed by a Web server engine 551. The Web server engine 551 runs in the same process as the database node instance for software performance reasons and to prevent process context-switching. The Web server engine 551 supports the HTTP 1.1 network protocol as defined by IEFT in RFC 2616, and the HTTP 2.0 network protocols as defined by LEFT in the HTTPbis Working Group Internet-Draft v7 dated Oct. 21, 2013. The Web server engine 551 can serve files 557 stored on the secondary storage 541 if so requested by the connected client software 530. The Web server engine 551 can be configured 564 to enable TLS/SSL data encryption 584 with server certificates and optionally client certificates by the DBA in the database node 531 instance configuration file 564. The context related to each client 530 connected to the Web server engine 551 is handled by a session manager 536b to prevent re-authentication after a network 532 disconnection of the client 530. Client authentication is handled by the Authentication Manager 595.

In some implementations, the Profiling endpoint 589 is managed by the Profiling server engine 553 network binding 536. The Profiling server engine 553 can be configured 564 to enable TLS/SSL data encryption 584 with server certificates by the DBA in the database node 531 instance configuration file 564. Raw text 592 is sent using push events 583 to all clients 530 connected to the Profiling endpoint 589 by the profiling server engine 553 over the profiling endpoint 589. The Event manager 582 decides what kind of events that are reported by the profiling server engine 553 and any event filtering, parsing, or processing is done by the receiving client 530 at their discretion. At the very simplest a common network tool like “netcat” can be used to monitor a DDBMS over a master database node 531 Profiling endpoint 589 from a remote client 530 over a telecommunications network 584.

All network bindings 536 can handle many concurrent executions and process these in parallel and at a serializable transaction isolation level.

Additionally, client software 530 may include various configurations to facilitate communication. For example, client software 530 may manage 590 over a telecommunications network 532 with a master database node 531 using a DDSTP endpoint 587 network binding 536, in such a case the client software must use the SparkleDB ODBC driver 534a1 and/or SparkleDB JDBC driver 534b1. Client software 535 may also manage 591 over a telecommunications network 532 with a master database 531 using a HTTP endpoint 588 network binding 536.

Client software 530 may also include various configurations for remote processing. For example, client software 535 may remotely monitor and analyze a DDBMS over a telecommunications network 532 with a master database node 531 using a Profiling endpoint 589 network binding 536. And client software 535 may remotely access 591 the DDBMS by connecting to a master database server node 531 using its HTTP endpoint 588. Client software 535 may also remotely access 590 the DDBMS by connecting to a master database server node 531 using its DDSTP endpoint 587 using the SparkleDB ODBC driver 534a1 and/or SparkleDB JDBC driver 534b1.

Further, a database administrator may remotely manage a DDBMS using the DBA Studio application 533. DBA Studio 533 requires 593 a SparkleDB JDBC driver 534b1 to connect to 590 a SparkleDB DDBMS DDSTP endpoint 586.

In the context of the network bindings 536, the DDSTP server engine 552 sends the DDSTP commands to the 531d Request handler 543 for their processing 537/542. The Web server engine 551 sends the HTTP request to the 531d Request handler 543 for processing 537/542 and retrieval 597 of web files 557. The Request handler 543 receives events from the 531a concurrency control 538, query processor 537, database engine 539, as well as every module or component of the DDBMS handled by these components.

Any event received by the Request handler 543 is reported to 531f the Event manager 582. The Event manager 582 report exceptions 581 events to the Exception handler 579 which stores server generated events in the 578 operating system event log 561.

If the Request handler 543 receives a 531d SPARQL query or other DML request then it is sent 531e for processing and execution to the Query processor 537, other kinds of requests are sent to 531g be processed and/or executed by other processors and parsers 542.

Further, some processors and parsers 542 may access 577 the secondary storage 541 directly, or access 531i other systems using the HTTP client 580. Some processors and parsers 542 may access 531j the database engine 539.

With regard to query handling, the Query processor 537 receives a 531e SPARQL query or other DML request from the Request Handler 543, parses it 547 to a lexicography of tokens, generates logical operators from the tokens 548, generate a query plan 549, optimizes 544 the query plan by processing algebra operators and generates 545 up to several alternative query plans by exploding the search′space, finally use database statistics from the System Catalog 562 and other means to estimate 546 the fastest query plan. The fastest query plan is executed 550 by the query processor 537 by the means of executing 550 the physical operators objects from the selected query plan after cost estimation 546 from the exploded search space. Some physical operator's that are executed by the Query Execution Engine 550 may access 531b the database engine 539.

The database engine's 539 Storage manager 568 determines which files and indexes are involved in a request in conjunction with the Indexes & Records manager 573. The database engine 539 components accesses 574/576 the storage devices 540/541. The file manager 570 accesses the secondary storage 541 and manages files on the node. The Disk Space Manager 571 has information about disk pages on all slave database nodes, which of these disk pages that are in use, and locked disk pages in conjunction with the Lock manager 538c. The Access Control Manager 572 manages user access to the database resources using access control lists, users and user groups, gathered from the System Catalog 562. The Index & records manager 573 has information about what logical files that are used with indexes and records. The Buffer Manager 569 has a buffer pool 565 in the Primary storage 540 containing cached disk pages on the current database node; when a disk page is read from the secondary storage it is cached in the buffer pool 565 primary storage 540 until the same disk page is overwritten or some other caching rule is in effect.

The Memory Manager 554 manages heap memory allocation and de-allocation using 575 its own heap memory buffer 567 in the Thread Local Storage 566 primary storage 540. The Thread Pool Manager 555 has a pool of pre-allocated threads and handles concurrent execution tasks.

The Systems Catalog 562 within RDF repository 560 holds metadata information like database statistics, DDL functions, DDL views, DDL procedures, access control lists, disk pages, indexes, records, logical files, and physical files about all the RDF repositories located on the slave database nodes. Here, such systems catalog 562 is resident only on the master(s).

Implementations may be configured with concurrency control 538 subcomponents and/or features to ensure that correct results for concurrent operations are generated. The Recovery Manager 538a fixes transactions that have rolled back and reads 531c the transaction log 559 for information on how to achieve this. The Transaction Log Manager 538b handles all reading and writing 531c to the Transaction Log 559. The Replication Engine 538d handles database node replication of data 558 and sends 531h DDSTP commands to other database nodes with the DDSTP Client 536a module, thusly managing them. The Transaction Manager 538e handles database transaction boundaries and demarcation.

Additionally, database services can be configured using the service configuration file 563 in the secondary storage 541. Any number of database services can be configured, each with any number of database instances within. Master database nodes can be configured using the instance configuration file 564 in the secondary storage 541.

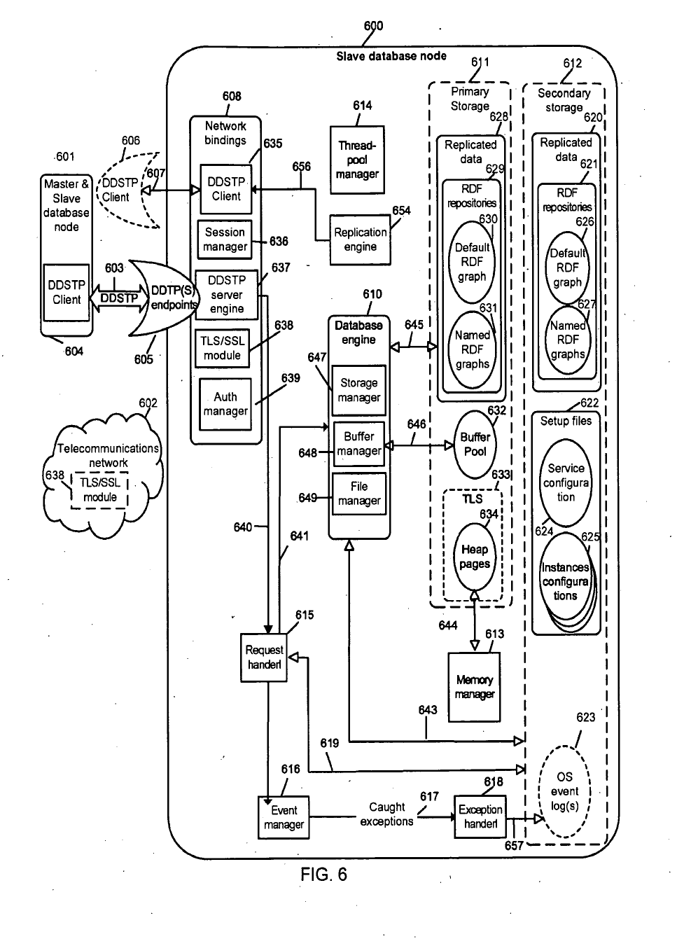

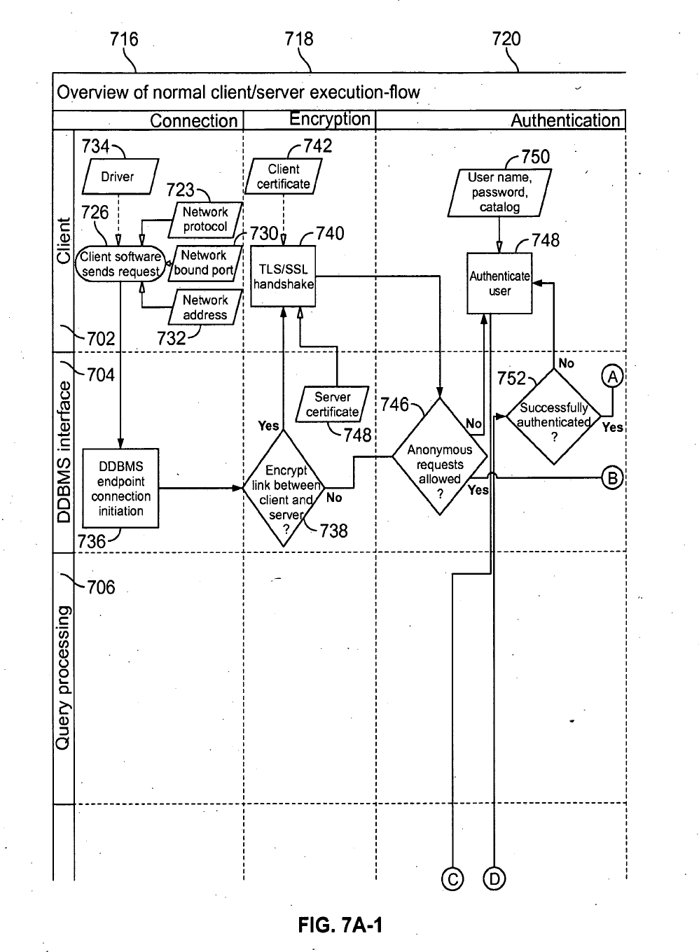

FIG. 6 depicts illustrative implementations/components of a distributed database management system (DDBMS) including a slave database node 600 and associated components and features, consistent with aspects related to the innovations herein. As set forth in FIG. 6, the DDBMS may include a slave database node 600, a master/slave database node 601, a telecommunications network 602 connecting the elements, and various communication/protocols associated with the slave 600 and master/slave 601, such as DDSTP communication 603, DDSTP client 635, and DDSTP endpoints 605.

Referring to FIG. 6, the master/slave 601 connects to a slave database node 600 over a network 602, such as a telecommunications network. The DDSTP endpoint 605 is managed by the DDSTP server engine 637 network binding 608. The DDSTP server engine 637 runs in the same process as the database node instance. The DDSTP server engine 637 can be configured 625 to enable TLS/SSL data encryption 638 with server certificates and optionally client certificates. Server TLS/SSL certificates are stored in the secondary storage 612 on the server system 600 and managed by the TLS/SSL module 638. The context related to each master/slave 601 connected to the DDSTP server engine 637 is handled by a session manager 636 to prevent re-authentication after a network 602 disconnection of a master/slave 601. Master/slave authentication is handled by the Authentication Manager 639.

Database server nodes communicate via DDSTP 603 with each other using a DDSTP client 635 module and DDSTP endpoints 605 over a network 602.

In one illustrative implementation, all network bindings 608 can handle many concurrent executions and process these in parallel and at a serializable transaction isolation level. Additionally, database nodes 601 may include various configurations to facilitate communication. For example, slave database node 601 may use the DDSTP protocol 607 and a DDSTP Client module 635 to connect to 607 a slave database node 600 over a telecommunications network 602 using a DDSTP endpoint 606 network binding 608. In the context of the network bindings 608, the DDSTP server engine 637 sends the DDSTP commands 640 to the Request handler 615 for their processing 610. The Request handler 615 sends events 641 received from the database engine 609 as well as every module or component of the DDBMS handled by the database engine 609.

Any event received by the Request handler 615 is reported to the Event manager 616. The Event manager 616 reports exceptions events 617 to the Exception handler 618 which stores server generated events 657 in the operating system event log 623.

The database engine's 610 Storage manager 647 determines which files and disk pages that are involved in the request or executes a function. The database engine 610 components accesses 643/645/646 the storage devices 611/612. The file manager 649 accesses the secondary storage 612 and manages files on the node The Buffer Manager 648 communicates 646 to a buffer pool 632 in the Primary storage 611 containing cached disk pages on the current database node; when a disk page is read from the secondary storage it is cached in the buffer pool 632 primary storage 611 until the same disk page is overwritten or some other caching rule is in effect.

The primary storage 611 includes replicated data 628 between slave database nodes 600 including RDF repositories 629 and may contain a default RDF graph 630 as well as named RDF graphs 631. Similarly, secondary storage 612 includes replicated data 620 between slave database nodes 600 including RDF repositories 621 and may have a default RDF graph 626 as well as named RDF graphs 627.

The Memory Manager 613 manages heap memory allocation and de-allocation using 644 its own heap memory buffer 634 in the Thread Local Storage 633 primary storage 611. The Thread Pool Manager 614 has a pool of pre-allocated threads and handles concurrent execution tasks.

The Replication Engine 654 handles slave database node 600 replication of data 620 and sends DDSTP commands 656 to other slave database nodes using the DDSTP Client 635 module.

Additionally, database services can be configured using the service configuration file 622 in the secondary storage 612. Any number of database services can be configured, each with any number of database instances within. Slave database nodes can be configured using the instance configuration file 625 in the secondary storage 612.

A slave database node can be configured to expose one or more network bindings that are used for management commands from the other database nodes that are part of the same DDBMS. To achieve this each database node is equipped with DDSPT endpoint (network APIs) network bindings that accept connections from DDSTP clients. Further, lock management concurrency control mechanisms of the slave's secondary storage disk pages is managed by the master nodes. Also, the Replication Engine makes sure that there is at least once copy of any physical file that is part of a RDF Repository to prevent a single point of failure in the DDBMS.

When an error is detected the replicated data, a transaction rollback has occurred, or a database node is offline from the DDBMS, then the Repair Manager will make sure that a new data replication is created from the good data to prevent further propagation of errors by the means inter-slave communication via DDSTP endpoints and DDSTP clients and DDSTP commands from the master database nodes.

In implementations herein, an RDF graph is considered a logical file, but can consist of many physical files distributed over many slave database nodes.

A slave database node not only operates as a component of a distributed database system but also a distributed computing platform since every slave database node can execute functions by command from the master database nodes if so required. This is achieved with functions, which are considered atomic in execution, that are managed by the database administrators as part of the Data Definition Language (DDL), these atomic functions can be executed in a distributed manner across the slave database nodes by command of the master database nodes and as requested by the client software calling DDL functions from the their Data Manipulation Language (DML) queries, for example from SPARQL queries.

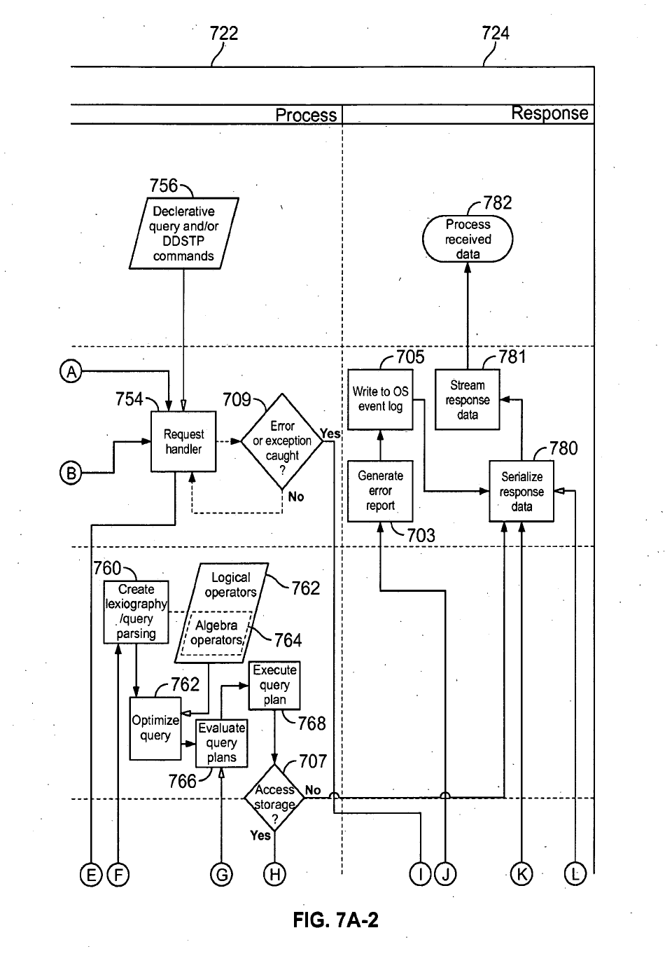

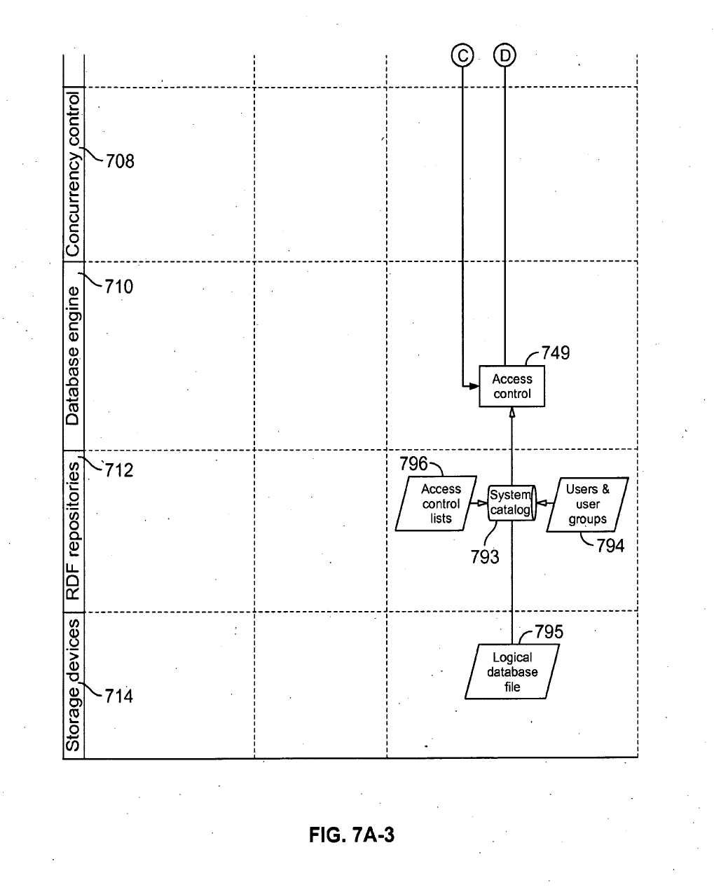

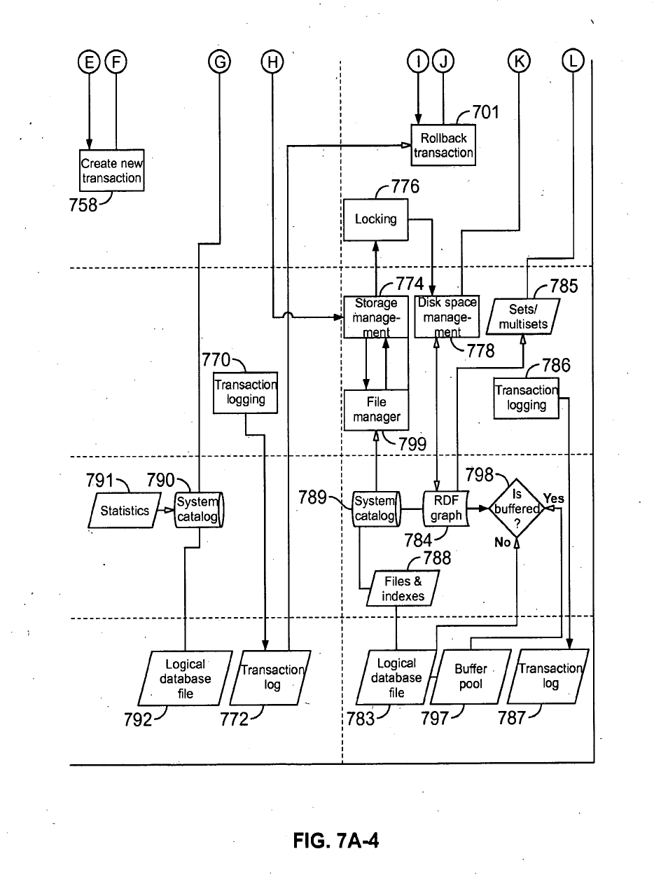

FIG. 7 illustrates one implementation of a client/server execution flow, consistent with aspects related to the innovations herein. Referring to FIG. 7, the vertical axis separates different processing/hardware layers and the horizontal axis shows the different overall steps performed. The processing/hardware layers include a client 702, DDBMS interface 704, query processor 706, concurrency control 708, database engine 710, RDF repositories 712 and storage devices 714. The main steps performed include connection over a telecommunication network 716, data encryption 718, user authentication 720, request processing 722 and response 724.

Client software at a client 702 sends request 726 by means of information about a network protocol 728, DDBMS network bound port socket number 730, DDBMS network address 732 and a optimally a SparkleDB driver 734. The request initiates a DDBMS endpoint connection 736 at the DDBMS interface 704 network endpoint. Determination of whether an encrypted link between the client and the server is required 738 is performed. If yes, a TLS/SSL handshake 740 is performed using a server certificate 744 and optionally a client certificate 742. The process proceeds to the determination of whether anonymous requests are allowed 746 after step 740 or if an encrypted link 738 is not required. If the anonymous request 746 is allowed, the request is processed by a request handler 754 based on a declarative query and/or DDSTP commands 756 from the client 702.

If anonymous requests 764 are not allowed, then user authentication 748 is performed using a user name, password and requested database catalog/RDF graph 750. Access control 749 of the database engine 710 determines successful authentication 752 using information stored in the system catalog 793 including users and user groups 794 and access control lists 796. The request is processed by the request handler 754 upon successful authentication.

All transaction logging 770 of the database engine 710 is stored in the transaction log 772. A transaction log 787 is created in the storage device 714 based on transaction logging 756 by the database engine. Also shown in FIG. 7, logical database files 795/792/783 relate to RDF repositories containing RDF graphs 784/790/793.

If an error or exception is caught during the processing of a request, a rollback transaction is performed if required by the concurrency controller 708 based on information stored in a transaction log 772 stored on a secondary storage device 714 After a successful transaction rollback the transaction log 770 is again updated. An error report is then generated by the DDBMS interface and is written to an OS event log. The error report is then formatted to an error report suited for a end user and serialized 780 and the response data is streamed 781 to the client 702 for possibly further processing of the received data 782.

A new transaction 758 may be created by the concurrency controller 708 and lexicography creation/query parsing 760 is handled by the query processor 706. The query is parsed into tokens and then converted to logical operators 762 including algebraic operators 764 and finally a query plan containing the operators. Thereafter, query optimization 762 is performed on a set of query plans after the search-space has exploded. The query plans are evaluated 768 information stored in the system catalog 790 RDF repository 712 including statistics. The query plan is considered most optimal is then selected and executed by the query executor 768. A determination of whether storage access is required is performed. If not, then the process proceeds to serializing the response data 780. Otherwise, the storage manager 774 of the database engine 710 provides storage access in conjunction with the lock manager 776 of the concurrency controller 708 and the file manager 799. The file manager 799 accesses the system catalog 789 including files and indexes 788 of logical database files 783.

The results of the lock manager 776 are provided to the disk space manager 778. The disk space manager 778 retrieves data from a RDF graph 784 in the RDF repositories 712 and then serializes the response data 780. Data from the RDF graph is retrieved from a buffer pool 7xz in the primary storage 714 if the related data is cached in the buffer pool 797 or from a logical database file if the related data is not cached in the buffer pool 797. Sets/multisets 785 are generated from the result of actions performed on the RDF graph 784 and sent serialized 780 in the DDBMS interface 704 before being streamed 781 back to the client 702 where the data may be further processed.

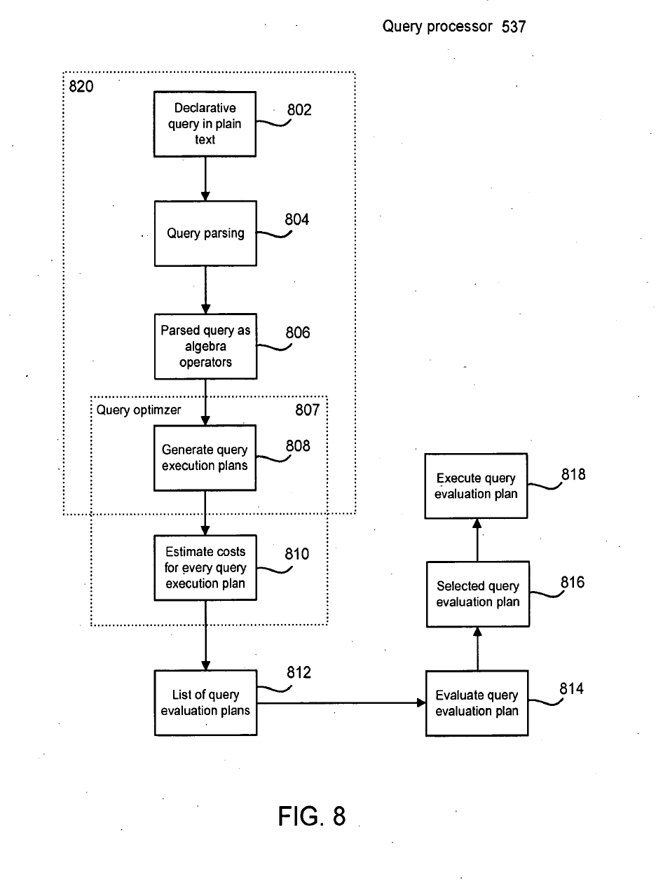

FIG. 8 shows an overview of an illustrative query processor 537, consistent with aspects related to the present innovations. According to some implementations, exemplary processing of the query processor may begin by accepting a declarative query 802 and parses the query 804 into algebraic operators 806.

With this parsed queries and algebraic operator information, processing may then proceed to a query optimization phase 807, which may include generating query execution plans 808 and estimating costs for every query execution plan 810. Next, the query processor may generate a list of the query evaluation plans 812 and evaluate the query execution plans 814. From there, an evaluation plan is selected 816 for executing the syntax, and then the best plan is executed 818.

Overall, the user/client interacts with the query processor, and the query processor in turn interacts with the storage engine. According to implementations herein, the query processor abstracts the details of execution such that the client submits the declarative query and the query processor determines the best plan to physically interact with the database storage engine. The ODBC driver performs the query parsing steps 804, 806, query optimizing steps 808, 810, and query plan evaluation steps 812-816 using database statistics before the selected query execution plan 816 is sent to the distributed database server. If the declarative query 802 is submitted over the SPARQL Protocol endpoint, the master database server node performs the query parsing 804, 806, query optimizing 808, 810, and query plan evaluation 812-816 using database statistics.

According to some embodiments herein, a portion of this initial query processing may be performed via the innovative client driver software herein. For example, the ODBC SparkleDB driver 543a1 and/or JDBC SparkleDB driver 543b1 may be configured to perform the steps of processing the declarative query in plain text 802, performing query parsing 804, processing the parsed query as algebraic operators 806, and estimating costs for every query execution plan 810.

In some implementations, the master database server node's query processor accepts a declarative query and parses the query into algebraic operators. The query plan evaluator processes the search space to find the most efficient query plan. The query optimizer removes the most obvious slow query plans when exploring the search space. The task of the operator evaluator is to use the search space subset and select a single plan. The query processor then selects an evaluation plan for executing the syntax, and then executes the best plan such that the query processor determines the best way to physically interact with the database storage engine. The selected plan is then later processed by the plan executor. The query plan evaluator uses algebraic expressions as an internal representation of queries, the algebra operators are logical operators and the physical operators are annotations on each node of the query plan expression tree that expresses the concrete physical implementation.

The operator evaluator takes into account the following physical properties of the system when evaluating each query plan in the search space: the presence or absence of indexes in the external memory input files, the sorted-ness of the external memory input files, the size of the external memory input files, the available space in the buffer pool, the buffer replacement policy, thread parallelism, distributed system node parallelism. A database backup can be stored on one or more storage devices.

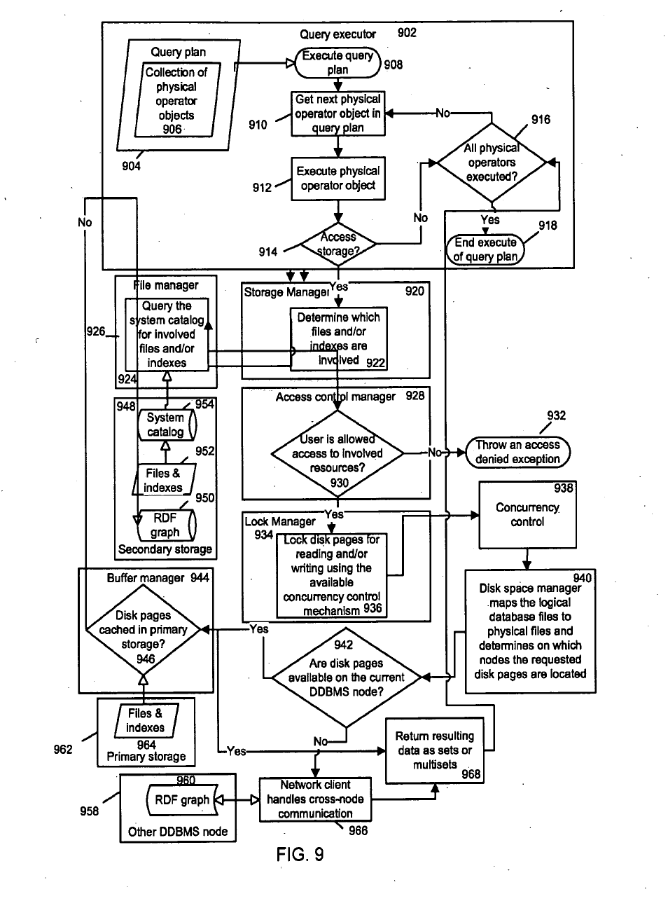

FIG. 9 is a flow diagram of illustrative database engine processing consistent with certain aspects related to the innovations herein. Referring to FIG. 9, one implementation of a query processing that begins in the query executor 902 is shown. Steps 906-918 are performed by the query executor 902. A query plan 904 is generated by collecting a set of physical operator objects at step 906. The query plan 904 is executed beginning at step 908 on the associated physical operator objects. The next physical operator object in the query plan is obtained at step 910. The obtained physical object is executed at step 912. A determination is performed whether storage needs to be accessed at step 914. If not, the process then determines if all physical operators have been executed at step 916. If so, the query plan execution ends at step 918 and returns the appropriate response to the client that initiated the request. Otherwise, the process returns to step 910 of obtaining the next physical operator object in the query plan. Some physical operators 906 may allow for parallel execution 912. At step 914, Yes, if storage access is required, the storage manager 920 performs step 922 of determining which files and/or indexes are involved, thusly involving the Indexes & Records Manager. The file manager 924 then queries 926 the system catalog 954 for the involved files and/or indexes 952 of the secondary storage 948 based on the determination result of step 922. Next, the access control manager 928 determines if the user that initiated the request is allowed access to the involved resources at step 930. If the user is not allowed access, then an access denied exception is thrown at step 932 and query execution stops. However, if the user is allowed access, the lock manager 934 at step 936 locks disk pages for reading and/or writing using the most appropriate concurrency control mechanism available on the database server node.

Concurrency control is thereafter performed at step 938, and is followed at step 940 by the disk manager mapping the logical database files to physical files on which nodes the requested disk pages are located. Then, step 942 determines whether disk pages are available on the current database node. If not, then the process continues at step 956 where the master database node network client 966 handles cross-node communication with an RDF graph 960 located on another slave database server node 958 in the DDBMS. Step 968 returns the resulting data as sets or multisets. The process then continues at step 916.

If the result of step 942 is yes, then the buffer manager 944 determines if the disk pages are cached in the primary storage at step 946. If yes, the buffer pool 964 of the secondary storage 962 is read from and the resulting data is returned at step 968. Otherwise, the RDF graph 950 of the secondary storage 948 is returned to the buffer manager 944.

Turning back to aspects of data definition language (DDL) processing, the distributed database server supports the management of custom stored procedures and functions. Each database server node support concurrent execution in separate threads which allows the database server node to operate faster on computer systems that have multiple CPUs and CPUs with multiple cores, and a multitude of protective measures has been taken to avoid race conditions. The database server's multithreaded execution model enables parallel execution on a multiprocessor system, thus allowing faster operation on computer systems that have multiple CPUs or CPUs with multiple cores.

A database server slave node persist the data on data storage devices such as hard disks. A database server slave node accepts create, read, update, and delete requests (CRUD) on data via the DDSTP endpoint or SPARQL Protocol endpoint and instructs the operating system to process the data on the data storage accordingly.

According to implementations herein, the distributed database server is fully serializable through snapshot isolation multiversion concurrency control (SI MVCC), which guarantees that all reads made in a transaction will see a consistent snapshot of a distributed database. A database in the distributed database server is the equivalent of a RDF graph as defined by W3C. A table in the distributed database server is the equivalent as a set of triples sharing the same named graph as defined by W3C. Each distributed database server has a single system catalog that contains metadata about the other databases in the distributed database server plus other information about the distributed database server. A distributed database server can contain any number of databases, limited by physical hardware resources. The database's conceptual schema is the equivalent of a RDF data model as defined by W3C. The database's logical and physical view are optimized for the RDF data model as defined by W3C, which has the advantage of simplifying and speeding up data processing between the database data model and the database reference model.

The distributed database server allows users to interactively interrogate the database and analyze and/or update its data according to the user's privileges on the data. The distributed database server automatically indexes structured data for faster inserting, retrieving and deleting of triples on the storage device. Distributed database server access controls govern what data are visible to different classes of users based on access control lists (ACL's). The distributed database server's declarative data definition language (DDL) extends SPARQL, which enables users to describe external and conceptual database schemas. The distributed database server has a Data Control Language (DCL) as an additional subset component to the DML that enables users to grant and revoke permissions to users and roles/groups for specific tasks. The distributed database server's declarative data manipulation languages (DML) complies with SPARQL 1.1 and SPARQL 1.1/Update as currently defined by W3C, thus enabling users to retrieve and manipulate data on the distributed database server. Users can define external schemas that are tailored to different user groups.

The distributed database server is able to run multiple databases on a single physical database server; each database runs its own concurrent execution or in its own thread. The distributed database server is capable of running several database server named instances in parallel, where each named instance is uniquely accessible by an application program over a telecommunications network.

The database server nodes have a uniform data storage interface that instructs the operating system to process the data on the data storage accordingly. The distributed database server enables schema constraint enforcement and rule enforcement for the conceptual schema of the database with RDF Schema (RDFS) as defined by W3C. The distributed database server allows for a schema-less data model that gives the DBA great flexibility and makes it easy to make later changes to the data model, commonly referred to a design-last approach.

Users and computer programs can access the distributed database server by accessing and using its SPARQL Protocol endpoint over a telecommunications network. The SPARQL Protocol endpoint is a RESTful API that is accessible over HTTP or HTTPS. Furthermore, in some implementations, the accessibility over HTTP may be further enabled and innovative as a function of a proprietary web server. For example, by utilization of the in-process multi-threaded Web server features disclosed herein, much faster SPARQL Protocol endpoint may be achieved versus a standard out-of-process web server. The SPARQL Protocol processes requests very fast since proprietary web server runs in the same process as the master database server node, thereby eliminating the need for cross-process communication and context-switching. A user/client performs create, read, update, and delete (CRUD) operations on the distributed database server with SPARQL 1.1 and SPARQL 1.1 Update queries over the DDSTP that are declarative query and update languages that comply with the W3C recommendations and current working drafts. Database statistics are used to calculate the likely processing time for each user requested SPARQL query and the endpoint can be configured to stop queries that take too long to process before the query is executed, thus preventing long running queries from consuming large amounts of database server system resources and also preventing denial of service attacks.

Some implementations may be configured with or for a database management graphical user interface (GUI), referred to as a DBA Studio, which is an optional GUI to let users/clients easily manage a distributed database server from a remote location across a network. When the DBA Studio starts, the user/client is prompted for a user name and a password that gives access to the requested distributed database server. The user specifies a distributed database server by entering its network address/name optionally in combination with the bound network port and/or the network protocol to use. One panel on the GUI contains a tree view control that lists all the databases, tables, external schemas, procedures, functions, ACL's, and logs available on the connected distributed database server. Another panel on the GUI contains one or several tabs, called query fields, where a user can write declarative queries. Yet another panel on the GUI contains buttons that performs actions for the user. One button executes the query written in a query field, another button lets the user disconnect from the currently connected distributed database server, and yet another button opens a dialog that lets the user connect to a distributed database server. Yet another panel on the GUI contains tabs that hold a single result set or multi-sets returned as a query result. Yet another panel on the GUI contains a drop-down menu that allows the user to quit DBA Studio and load/save queries from/to data storage memory like a hard disk.

In the present description, the terms component, module, and functional unit, may refer to any type of logical or functional process or blocks that may be implemented in a variety of ways. For example, the functions of various blocks can be combined with one another into any other number of modules. Each module can be implemented as a software program stored on a tangible memory (e.g., random access memory, read only memory, CD-ROM memory, hard disk drive) to be read by a central processing unit to implement the functions of the innovations herein. Or, the modules can comprise programming instructions transmitted to a general purpose computer or to graphics processing hardware via a transmission carrier wave.

Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, embodiments and features of the invention may be implemented through computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe components such as software, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various processes and operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) that may be used to transfer such formatted data and/or instructions through wireless, optical, or wired signaling media or any combination thereof.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Other embodiments of the invention will be apparent to those skilled in the art from consideration of the specification and practice of the invention disclosed herein. It is intended that the specification and examples be considered as exemplary only, with a true scope and spirit of the inventions herein being given by the disclosure above in combination with the following paragraphs describing the scope of one or more embodiments of the following invention.

1. A method for performing database management utilizing distributed Resource Description Framework (RDF) repositories, the method comprising
providing transaction management via a concurrency controller;
processing data between the concurrency controller and storage via a database engine, the storage comprising a first storage and a second storage; and
performing query processing via a query processor connected with the database engine.

2. A method for performing database management utilizing distributed Resource Description Framework (RDF) repositories, the method comprising:
providing transaction management via a concurrency controller;
processing data between the concurrency controller and storage via a database engine, the storage comprising a first storage including a buffer pool and a second storage including second replicated data and configuration data; and
performing query processing via a query processor connected with the database engine;
connecting at least one network binding component with the database engine, wherein the at least one network binding component comprises one or more subcomponents including a web server engine for data interchange, wherein the web server engine runs in-process with a master database node.

3. (canceled)

4. The method of claim 1, wherein the HTTP endpoint supports at least one of SPARQL 1.1 protocol, HTTP 1.1 network protocol, and HTTP 2.0 network protocol.

5.-10. (canceled)

11. The method of claim 1 further comprising utilizing a master database node comprising:
a concurrency controller providing transaction management;
a database engine connecting the concurrency controller with storage, the storage connected with the database engine comprising a first storage including a buffer pool and a second storage including second replicated data and configuration data;
a query processor connected with the database engine and configured to perform query processing;
at least one network binding component connected with the database engine.

12. The method of claim 2, the master database node comprising:
a concurrency controller providing transaction management;
a database engine connecting the concurrency controller with storage, the storage connected with the database engine comprising a first storage including a buffer pool and a second storage including second replicated data and configuration data;
a query processor connected with the database engine and configured to perform query processing;
at least one network binding component connected with the database engine and comprising one or more subcomponents including a web server engine for data interchange, wherein the web server engine runs in-process with the master database node.

13.-14. (canceled)

15. The method of claim 1, wherein the concurrency control includes a recovery manager, transaction log manager, lock manager, replication engine and transaction manager.

16. The method of claim 1, wherein the database engine includes a storage manager, buffer manager, file manager, disk space manager, access control manager, and indexes and records manager.

17. The method of claim 1, wherein the replicated data of the second storage includes a transaction log and RDF repositories including a system catalog.

18. The method of claim 1, wherein the system catalog includes metadata associated with at least one slave database management server node, wherein the metadata includes database statistics, DDL functions, DDL views, DDL procedures, access control lists, disk pages, indexes, records, logical files an physical files associated with all RDF repositories of slave database nodes.

19.-20. (canceled)

21. The method of claim 1, wherein the concurrency control includes replication engine replicating data across a plurality of slave nodes.

22.-23. (canceled)

24. The method of claim 2, wherein the master server node receives federated queries via an HTTP endpoint.

25.-28. (canceled)

29. The method of claim 1, wherein the query processor receives a query or data manipulation language (DML) request and includes a query lexer, an operator evaluator, query optimizer, a plan generator, a plan cost estimator,
wherein
the query lexer parses the query or DML request into a set of tokens,
the operator evaluator generates logical operators based on the tokens,
the query optimizer optimizes the query based on the logical operators,
a plan generator generates a plurality of query plans based on the optimized query,
a plan cost estimator estimating a fastest query plan,
the query processor executes the fastest query plan.

30.-33. (canceled)

34. The method of claim 1, wherein the buffer manager manages the buffer pool including cached disk pages on the master database server node, wherein a display page read from the second storage is cached in the buffer pool until overwritten.

35. The method of claim 1, further comprising:
a memory manager managing heap memory allocation/de-allocation using a heap memory buffer in thread local storage of the first storage.

36.-38. (canceled)

39. The method of claim 59, wherein the replication engine manages database node replication and transmits DDSTP commands to slave database nodes.

40.-41. (canceled)

42. The method of claim 1 further comprising:
receiving a query plan including a set of physical object operators;
executing the query plan sequentially on each of the physical object operators;
determining logical database files corresponding to the executed physical object operator;
providing concurrency control on the determined logical database files;
mapping the logical database files to physical files;
determining a node(s) the physical files are located;
retrieving the physical files from the determined node(s).

43.-53. (canceled)

54. The method of claim 1 further comprising:
performing processing involving parsing and/or handling algebraic operators associated with the query;
performing query optimization processing including generating one or more query execution plans and estimating costs for the query execution plans;
processing a list of query evaluation plans;
evaluating, via a query plan evaluator, at least one of the query evaluation plans to select a query evaluation plan that yields a best way to physically interact with a database storage engine of the distributed database management system; and
executing the selected query execution plan.

55.-58. (canceled)

59. A method for processing information associated with a distributed RDF database management system using ODBC, the method comprising:
connecting a master database server node to one or more slave database server nodes via a distributed database server transaction protocol (DDSTP) endpoint;
enforcing, via a distributed database server, data integrity constraints and access controls to different classes of users;
performing processing, via the distributed database server, to support atomicity, consistency, isolation and durability (ACID);
providing, via the master database server node, crash recovery by utilizing a write-ahead log (WAL);
performing processing, via the slave database server node, regarding accepting, creating, reading, updating and deleting requests (CRUD); and
serializing the distributed database management system, via snapshot isolation, involving multiversion concurrency control (SI MVCC).

60.-72. (canceled)

73. The method of claim 59 including distributed query pre-processing, wherein some of the query processing is configured to occur in the ODBC driver, taking the processing load off the master database node.

74.-86. (canceled)

87. The method of claim 59 wherein the DDSTP endpoint is configured to stop queries that take too long to process before the query is executed, thus preventing long running queries from consuming large amounts of database server system resources and also preventing denial of service attacks.
